(19) United States
(12) Patent Application Publication
(10) Pub. No.: US 2020/0322298 A1
(43) Pub. Date: Oct. 8, 2020

(54) ELECTRONIC MESSAGE REPLY CRITERIA TRACKING AND COMPENSATION INITATION SYSTEM

(71) Applicant: Dylan Wetherill Delancey, Prairie Village, KS (US)

(72) Inventor: Dylan Wetherill Delancey, Prairie Village, KS (US)

(21) Appl. No.: 16/842,653

(22) Filed: Apr. 7, 2020

Related U.S. Application Data
(60) Provisional application No. 62/920,011, filed on Apr. 8, 2019.

(51) Int. Cl. H04L 12/58; H04W 4/12

(52) U.S. Cl. CPC H04L 51/14; H04W 4/12; H04L 51/34; H04L 51/12

(57) ABSTRACT

A server includes a database having a message table stored thereon. The message table includes a plurality of message records. The server also includes a processor in communication with the database. The processor is programmed to receive, from a sender via a remote computing device, input data associated with a compensation message. The input data includes a reply compensation value, a reply deadline, a recipient, and message content. The server generates the compensation message based on the input data and transmits the compensation message to the recipient. Furthermore, the server receives a reply message from the recipient. The reply message is associated with the compensation message. The server determines that the reply message was received before or equal to the reply deadline and determines a compensation value associated therewith based on the reply compensation value.

### CROSS-REFERENCE TO RELATED APPLICATIONS

The present application claims priority from U.S. Provisional Patent Application No. 62/920,011, filed Apr. 8, 2019, and entitled ELECTRONIC MESSAGE REPLY CRITERIA TRACKING AND COMPENSATION INITIATION SYSTEM, the entire disclosure of which is hereby incorporated by reference herein.

### FIELD OF THE DISCLOSURE

The field of the disclosure relates generally to message systems and, more particularly, to methods and systems for compensating a message recipient for replying to a message.

### BACKGROUND OF THE DISCLOSURE

Message systems, such as SMS messages and the like, enable users to conveniently send brief messages to other users without the need to call the user or otherwise speak to the user. Recipients of such messages, however, may be inclined to simply read the message and not reply, or simply ignore the message altogether. Known message systems do not enable a sender to incentivize and otherwise induce a recipient to read and respond to a message. As a result, there is a need for a message system that provides a mechanism for a send to induce a reply message from a recipient.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a server is provided. The server includes a database including a message table having a plurality of message records, and a processor in communication with the database. The processor is programmed to receive, from a sender via a remote computing device, input data associated with a compensation message. The input data includes a reply compensation value, a reply deadline, a recipient, and message content. The processor is also programmed to generate the compensation message based on the input data and transmit the compensation message to the recipient. Furthermore, the processor is programmed to receive a reply message from the recipient. The reply message is associated with the compensation message. Moreover, the processor is programmed to determine that the reply message was received before or equal to the reply deadline and determine a compensation associated with the reply message based on the compensation.

In another aspect, a method is provided. The method includes receiving, from a sender via a remote computing device, input data associated with a compensation message. The input data includes a reply compensation value, a reply deadline, a recipient, and message content. The method also includes generating the compensation message based on the input data and transmitting the compensation message to the recipient. Furthermore, the method includes receiving a reply message from the recipient. The reply message is associated with the compensation message. Moreover, the method includes determining that the reply message was received before or equal to the reply deadline and determining a compensation value associated with the reply message based on the reply compensation value.

In yet another aspect, one or more non-transitory computer-readable storage media having computer-executable instructions embodied thereon is provided. When executed by at least one processor, the computer-executable instructions cause the processor to receive, from a sender via a remote computing device, input data associated with a compensation message. The input data included a reply compensation value, a reply deadline, a recipient, and message content. The computer-executable instructions also cause the processor to generate the compensation message based on the input data and transmit the compensation message to the recipient. Furthermore, the computer-executable instructions cause the processor to receive a reply message from the recipient, the reply message associated with the compensation message. Moreover, the computer-executable instructions cause the processor to determine that the reply message was received before or equal to the reply deadline and determine a compensation value associated with the reply message based on the reply compensation value.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example electronic message reply compensation system including a messaging service system, in accordance with one embodiment of the present disclosure;

FIG. 2 is an example configuration of a message server of the messaging service system shown in FIG. 1;

FIG. 3 is an example configuration of a client system for use in the electronic message reply compensation system shown in FIG. 1;

FIG. 4 is an example configuration of a server system for use in the electronic message reply compensation system shown in FIG. 1;

FIG. 5 is a schematic illustration of the message table including a compensation message record;

FIG. 6 is a schematic illustration of the message table shown in FIG. 5, including the compensation message record and a reply message record;

FIG. 7 is a flowchart illustrating an exemplary computer-implemented method for determining a compensation amount owed to a message recipient for replying to a compensation message, in accordance with one embodiment of the present disclosure.

FIG. 8 is a flowchart illustrating the details of an operation of the method shown in FIG. 7; and

FIG. 9 is a flowchart illustrating the details of another operation of the method shown in FIG. 7.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

### Network System

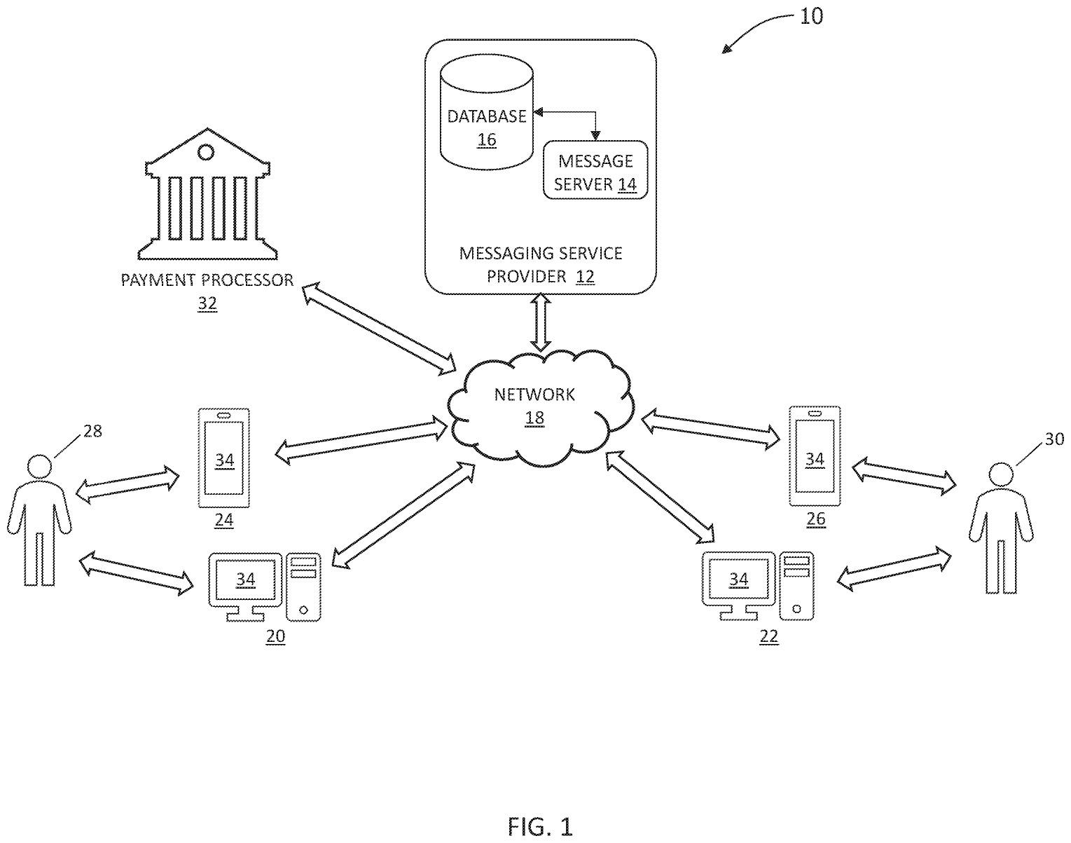

FIG. 1 is a block diagram of an example electronic message reply compensation system 10, in accordance with one embodiment of the present disclosure. The electronic message reply compensation system 10 includes a messaging service system 12 having a message server 14 coupled to a database 16. In addition, the electronic message reply compensation system 10 includes a plurality of user devices, such as computing devices 20, 22 and/or mobile computing devices 24, 26. A plurality of users, such as users 28 and 30, interact with one or more of the computing devices 20, 22 and/or mobile computing devices 24, 26 to transmit/receive electronic messages to/from other users via the messaging service system 12. To transmit/receive electronic messages via the messaging service system 12, the computing devices 20, 22 and/or mobile computing devices 24, 26 are coupled in communication with the messaging service system 12, and more particularly, with the message server 14, via a communications network 18. Furthermore, the electronic message reply compensation system 10 includes a third-party payment processor 32 configured to processes payments among the users 28, 30 and the messaging service system 12. Although parts of the electronic message reply compensation system 10 are presented in one arrangement, other embodiments may include the same or different parts arranged otherwise, depending, for example, communication between computing devices, etc.

In the example embodiment, the communications network 18 includes, for example and without limitation, one or more of a local area network (LAN), a wide area network (WAN) (e.g., the Internet, etc.), a mobile network, a virtual network, and/or any other suitable public and/or private network capable of facilitating communication among the computing devices 20, 22, the mobile computing devices 24, 26, and/or the messaging service system 12. In some embodiments, the network 18 includes more than one type of network, such as a private transaction network provided between the messaging service system 12 and the payment processor 32, and separately, the public Internet, which may facilitate communication between the computing devices 20, 22 and/or mobile computing devices 24, 26 and the messaging service system 12.

With continued reference to FIG. 1, in the exemplary embodiment, each of the computing devices 20, 22 and/or mobile computing devices 24, 26 (e.g., a smartphone or other computing device used by the users 28, 30) includes a user interface 34 that facilitates user interaction with the respective computing device. For example, and without limitation, the user interface 34 enables the users 28, 30 to input information to the computing device 20, 22, 24, or 26, and the computing device to output information to the users 28, 30 (e.g., on a display of the computing device). The user interface 34 enables interaction with, for example, a messaging application that is installed on the computing devices 20, 22, 24, and 26. In the exemplary embodiment, the messaging application is associated with the messaging service system 12. It is contemplated that fewer or more software applications may be installed on the computing devices 20, 22, 24, and 26 and displayed by the associated user interface 34.

In the exemplary embodiment, the computing devices 20, 22, 24, and 26 communicate with the messaging service system 12, for example, via the network 18, to transmit and/or receive electronic messages to one or more other users (e.g., users 28 and 30) that are participants of a messaging service offered by the messaging service system 12. The computing devices 20, 22, 24, and 26 can be any computing device capable of interconnecting to the network 18, such as the Internet, including a desktop computer, laptop, tablet, mobile web-based device, smartphone, PDA, or other web-based connectable equipment. The computing devices 20, 22, 24, and 26 are interconnected to the Internet through one or more interfaces including a network, such as a local area network (LAN) or a wide area network (WAN), dial-in-connections, cable modems, wireless modems, special high-speed ISDN lines, Global System for Mobile communications (GSM), 3G, 4G, and 5G mobile communications, and/or other data networks.

The messaging service system 12 includes, for example, and without limitation, a computer, a server, a network of multiple computing devices, a virtual computing device, or the like. The messaging service system 12 includes, for example, and without limitation, a web application, an application programming interface (API) server, and/or a memory device enabling the computing devices 20, 22 and/or mobile computing devices 24, 26 to be in communication with the messaging service system 12 using, for example, and without limitation, the Internet. As described above, the computing devices 20, 22 and/or mobile computing devices 24, 26 are interconnected to the Internet through one or more interfaces including a network, as detailed above.

Furthermore, as discussed above, the messaging service system 12 includes, for example, the message server 14, which is connected to the database 16. In one embodiment, the database 16 is stored on the message server 14. In an alternative embodiment, the database 16 may be stored remotely from the message server 14 and may be non-centralized. The database 16 is configured to receive and store user account information, message entries, and/or rules and monetary values associated with those accounts and/or message entries.

In the exemplary embodiment, a user, such as the user 28 (the “sender”), participates in the message service by recording an electronic message, selecting one or more other users of the messaging service to receive the recorded message, and providing a reply compensation value and reply deadline to be associated with the recorded message. The messaging service system 12 notifies each of the users selected to receive the recorded message (the “recipients”) that they have a message waiting for them to open. For example, each recipient may be notified via the messaging application that is installed on their computing device 20, 22, 24, or 26. A recipient opens the messaging application and is provided the recorded message, the reply compensation value, and the reply deadline associated with the recorded message. If the recipient selects to reply to the message, the messaging service system 12 records the reply message and the time of the reply. Based on the time of the reply and the reply compensation value, the messaging service system 12 determines a total reply compensation amount owed to the recipient and provides payment transaction data to the payment processor 32 to process the transaction between the sender and the recipient.

### Exemplary Computer Systems

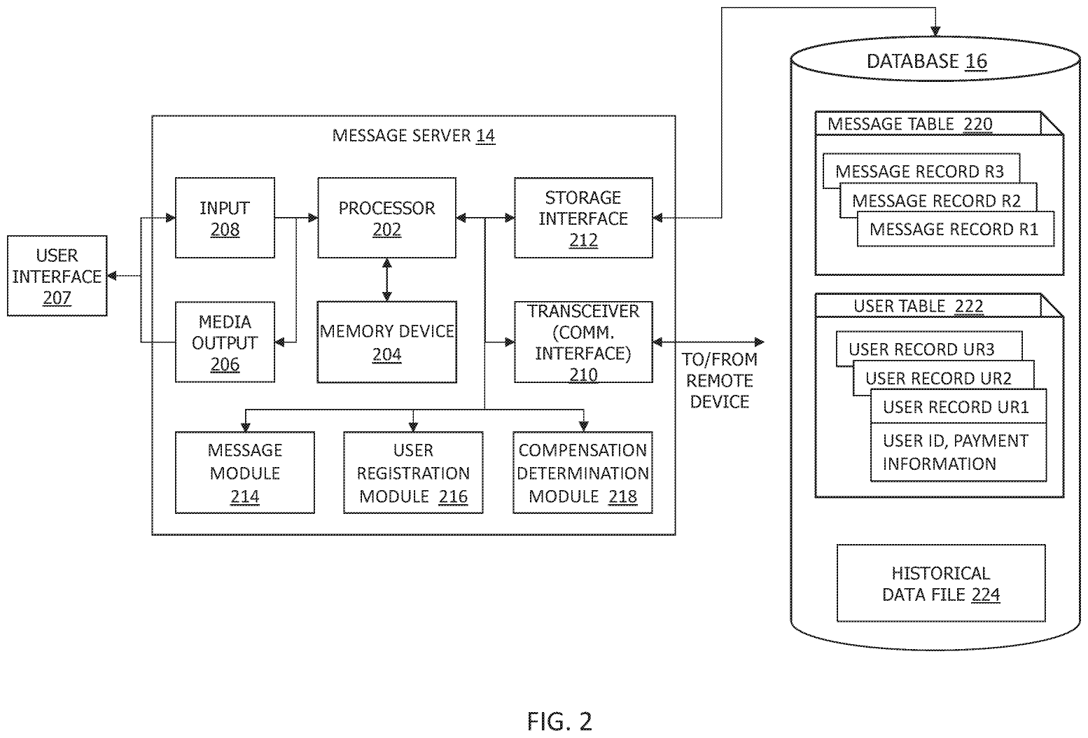

FIG. 2 is an example configuration of the message server 14, which is part of the messaging service system 12 (shown in FIG. 1), in accordance with one aspect of the present disclosure. In the exemplary embodiment, the message server 14 is a computing device configured to connect to one or more of the computing devices 20, 22, the mobile computing devices 24, 26, and/or any other computing devices, such as computing devices (not shown) of the payment processor 32 (shown in FIG. 1), via the network 18.

In the example embodiment, the message server 14 includes one or more processors 202 for executing instructions. In some embodiments, the executable instructions are stored in a memory device 204. The processor 202 includes, for example, and without limitation, one or more processing units arranged, for example, in a multi-core configuration for executing the instructions. The instructions may be executed within a variety of different operating systems on the message server 14, such as UNIX, LINUX, Microsoft Windows®, etc. More specifically, the instructions may cause various data manipulations on data stored in database 16 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 204 is any device allowing information such as the executable instructions, data, and/or written works to be stored and retrieved. The memory device 204 includes one or more computer readable media. The processor 202 is operable to execute the executable instructions, contained in program instructions, operations, and/or steps described herein, so as to control the message server 14 to provide desired functionality.

The message server 14 also includes at least one media output component 206 for presenting information to a user, such as a server administrator (not shown). The media output component 206 is any component capable of conveying information to the user. In some embodiments, the media output component 206 includes an output adapter such as a video adapter and/or an audio adapter. An output adapter is operatively coupled to the processor 202 and operatively connectable to an output device, including for example, and without limitation, a display device, a liquid crystal display (LCD), light emitting diode (LED) display, organic light emitting diode (OLED) display, “electronic ink” display, etc. and/or an audio output device, such as a speaker, or headphones.

In certain embodiments, the message server 14 includes an input device 208 for receiving input from the user. The input device 208 includes, for example, and without limitation, a touch sensitive panel, a touch pad, a touch screen, a stylus, a keyboard, a pointing device, a mouse, and/or an audio input device. A single component such as a touch screen may function as both an output device of the media output component 206 and the input device 208.

The message server 14 also includes a transceiver 210 (broadly, a communication interface), which is communicatively connectable to one or more remote devices such as the computing devices 20, 22, the mobile computing devices 24, 26, and/or any other computing devices via, for example, the network 18 (shown in FIG. 1). The transceiver 210 includes, for example, and without limitation, a wired or wireless network adapter or a wireless data transceiver for use with radio frequency communication, near field communication (NFC), and/or with a mobile phone network, Global System for Mobile communications (GSM), 3G, 4G, 5G, or other mobile data network, and/or Worldwide Interoperability for Microwave Access (WiMax) and the like. The transceiver 210 includes, for example, numerous communication ports (not shown) to enable the message server 14 to communicate simultaneously with a number of other computers and other devices, including communications as required to simultaneously handle numerous transactions.

Stored in the memory device 204 are, for example, computer readable instructions for providing a user interface 207 to the user via the media output component 206 and, optionally, receiving and processing input from the input device 208. The user interface 207 includes, among other possibilities, a web browser and various software applications. Web browsers enable users to display and interact with media and other information typically embedded on a web page or a website. The various software applications allow the user to interact with the message server 14 to further communicate with the computing devices 20, 22, the mobile computing devices 24, 26, etc. to facilitate providing various services to the users 28, 30 (shown in FIG. 1).

The memory device 204 includes, for example, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

The database 16 is any computer-operated hardware suitable for storing and/or retrieving data. In certain embodiments, the database 16 is integrated into the message server 14. The message server 14 includes, for example, and without limitation, one or more hard disk drives that function as the database 16. In other embodiments, the database 16 is external to the message server 14 and may be accessed, for example, by one or more database servers. For example, the database 16 includes multiple storage units such as hard disks or solid-state disks in a redundant array of inexpensive disks (RAID) configuration. The database 16 includes, for example, and without limitation, a storage area network (SAN) and/or a network attached storage (NAS) system.

In some embodiments, the processor 202 is operatively coupled to the database 16 via a storage interface 212. The storage interface 212 is any component capable of providing the processor 402 with access to the database 16. The storage interface 212 includes, for example, and without limitation, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 16.

In certain embodiments, it is contemplated that the message server 14 is implemented as a software application. In such embodiments, the hardware described above, such as the processor 202, the memory device 204, the transceiver 210, and/or the storage interface 212 may be shared with the hardware components of another database server (not shown).

The message server 14 also includes a message module 214. The message module 214 is configured to monitor the network connections with the computing devices 20, 22 and the mobile computing devices 24, 26, for example, via the transceiver 210, to identify message exchanges and compensation message requests received from users, such as the users 28, 30. The message module 214 writes records corresponding to the messages and compensation message requests to one or more tables stored on the database 16, such as a message table 220. That is, each message is associated with a message record. In one suitable embodiment, the message table 220 includes, for example, a plurality of rows or records, such as message records R₁, R₂, R₃. Each of the message records R₁, R₂, R₃ is associated with a respective user identifier (ID) and includes, for example, a plurality of data fields (e.g., columns of the table), as described further herein. The data fields include, for example, and without limitation, at least a field for the user ID, unique message ID, time of the message request, and the message text and/or message data file pointer. It is noted that the message records and/or data fields of the message records (e.g., columns of the table) can be stored in one or more tables, span one or more tables, and the like. For example, in one embodiment, the data fields associated with the message records may be split into two or more tables. In another embodiment, the message records may be written to different tables, depending, for example, on the type of message record (e.g., compensation message, reply message, etc.).

A registration module 216 is configured to communicate with the computing devices 20, 22 and/or mobile computing devices 24, 26 to receive user information from the user 28, 30 during a registration process. The registration module 216 writes the received user information to one or more tables stored on the database 16, such as a user table 222. In one suitable embodiment, the user table 222 includes, for example, a plurality of rows or records, such as user records UR₁, UR₂, UR₃. Each of the user records UR₁, UR₂, UR₃ is associated with a respective user identifier (ID) and includes, for example, a plurality of data fields (e.g., columns of the table). The data fields include, for example, and without limitation, at least a field for the user ID, user payment information (e.g., payment token), payment sender identification, payment receiver identification, and compensation amount.

The message server 14 also includes a compensation determination module 218 configured to determine a compensation amount owed to a user, such as the user 30 (the “recipient”) for replying to a compensation message. As described above, a user, such as the user 28 (the “sender”), may transmit a compensation message to the recipient. The compensation message is associated with a reply compensation value and reply deadline. As described further herein, the reply compensation value can be a fixed value, payable in full to a user that replies to the compensation message at any time before or equal to the reply deadline, or a variable value that decreases as the reply deadline approaches.

In addition, the compensation determination module 218 may function as a transaction processing application for executing payment transactions on behalf of the users, such as the sender. The transaction processing application may receive payment device details from the sender, for example, from the user table 222 or via his or her computing devices 20, 22, 24, or 26, for compensating the recipient for replying to his or her compensation message. For example, in one embodiment, the transaction processing application may read payment card account details from the user table 222 or the user's digital wallet stored on the computing device 20, 22, 24, or 26, and transmit payment transaction data to the payment processor 32 to process a transaction between the sender and the recipient, for example, by generating one or more payment authorization requests that are routed to an appropriate payment system (not shown).

In the exemplary embodiment, the compensation determination module 218 is configured to provide the payment transaction data to the payment processor 32 upon receipt of a reply message to which compensation is owed. Alternatively, the payment transaction data may be provided to the payment processor 32 at predetermined intervals, such as one (1) second, one (1) minute, five (5) minutes, sixty (60) minutes, daily (once per twenty-four (24) hours), etc. In an example embodiment, the compensation amount owed may be written to memory device 204, for example, is a user accessible portion, so that a user can quickly analyze the transaction data, such as determining the total compensation amount owed per user, total number of transactions between users, etc. Alternatively, or in addition, the compensation determination module 218 may be configured to write the payment transaction data to a historical data file 224.

In the exemplary embodiment, the database 16 and/or memory device 204 stores one or more programs for controlling the processor 202. The programs include program instructions, operation, and/or steps (which may be referred to as computer-readable instructions) that contain executable operations of the message server 14. When the processor 202 executes the computer-readable instructions, it causes the message server 14 to function as described herein.

The programs include, for example, one or more conventional operating systems (not shown) that control the processor 202 so as to manage and coordinate activities and sharing of resources in the wallet message server 14, and to serve as a host for application programs that run on the message server 14. The one or more conventional operating systems include, for example, and without limitation, UNIX, LINUX, Microsoft Windows®, macOS®, OS X®, etc. More specifically, the computer-readable instructions may cause various data manipulations on data stored in the database 16 (e.g., create, read, update, and delete procedures). It should also be appreciated that upon initiation of a computer-based method, various computer-readable instructions may be executed during initialization. Some operations may be required to perform one or more processes described herein, while other operations may be more general and/or specific to a programming language (e.g., C, C#, C++, Java, or other suitable programming languages, etc.).

The database 16 and/or memory device 204 includes, for example, a user registration application (not shown) that, when executed by the processor 202, enables the message server 14 to handle requests from users, such as the users 28, 30 (shown in FIG. 1), to register for messaging services provided by the message server 14. Using the user registration application, the user 24 may create his or her messaging account. The messaging account operates to allow the users 28, 30 to participate in the messaging services offered by the messaging service system 12 and operated by the message server 14.

The user 28, 30 may register for a messaging account with the messaging service system 12 by interacting with a webpage that is hosted by the messaging service system 12. After the user 28, 30 has established his or her account via the webpage, he or she may add payment details for sending/receiving payments for interacting with the messaging service system 12. For example, the user 28, 30 may add one or more of his or her payment cards and/or accounts to his or her messaging account. In one suitable embodiment, the user 28, 30 authorizes the messaging service system 12 work with the payment processor 32 to contact card issuers of the payment card accounts to initiate a process of inputting the relevant payment account data into a digital wallet stored with the user's messaging account.

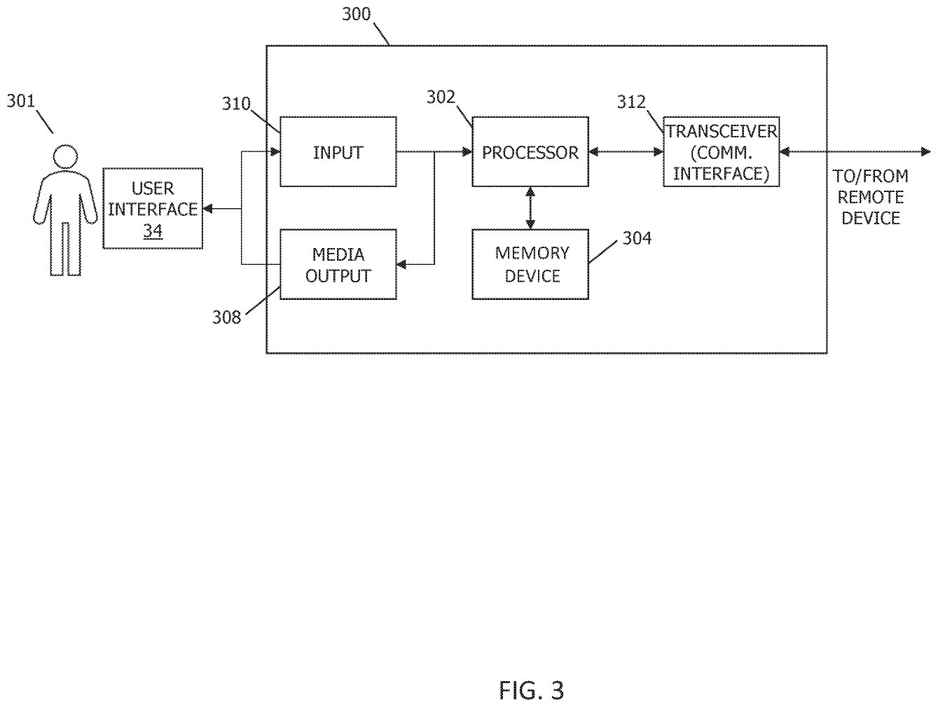

FIG. 3 is an example configuration of a client system 300 operated by a user 301. In some embodiments, the client system 300 is a user computing device 20, 22, 24, or 26 (each shown in FIG. 1). In addition, the user 301 may be the user 28 or 30 (shown in FIG. 1). In the example embodiment, the client system 300 includes one or more processors 302 for executing instructions. In some embodiments, executable instructions are stored in a memory device 304. The processor 302 includes, for example, one or more processing units arranged, for example, in a multi-core configuration. The memory device 304 is any device allowing information such as executable instructions, data, and/or written works to be stored and retrieved. The memory device 304 includes one or more computer readable media.

The client system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the client system 300 includes an input device 310 for receiving input from the user 301. The input device 310 includes, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 308 and the input device 310. The client system 300 may also include a transceiver 312 (broadly, a communication interface), which is communicatively connectable to a remote device such as the message server 14 (shown in FIG. 1). The transceiver 312 includes, for example, a wired or wireless network adapter or a wireless data transceiver for use with radio frequency communication, near field communication (NFC), and/or with a mobile phone network, Global System for Mobile communications (GSM), 3G, 4G, 5G, or other mobile data network, and/or Worldwide Interoperability for Microwave Access (WiMax) and the like.

Stored in the memory device 304 are, for example, computer readable instructions for providing the user interface 34 to the user 301 via the media output component 308 and, optionally, receiving and processing input from the input device 310. The user interface 34 includes, among other possibilities, a web browser and various software applications. Web browsers enable users to display and interact with media and other information typically embedded on a web page or a website. The various software applications allow the user 301 to interact with the client system 300 to further communicate with the message server 14, other user mobile devices, other computing systems, payment systems, etc. to facilitate transmitting and/or receiving compensation messages and reply messages provided by the messaging service system 12, and optionally, execute a transaction upon delivery of such services.

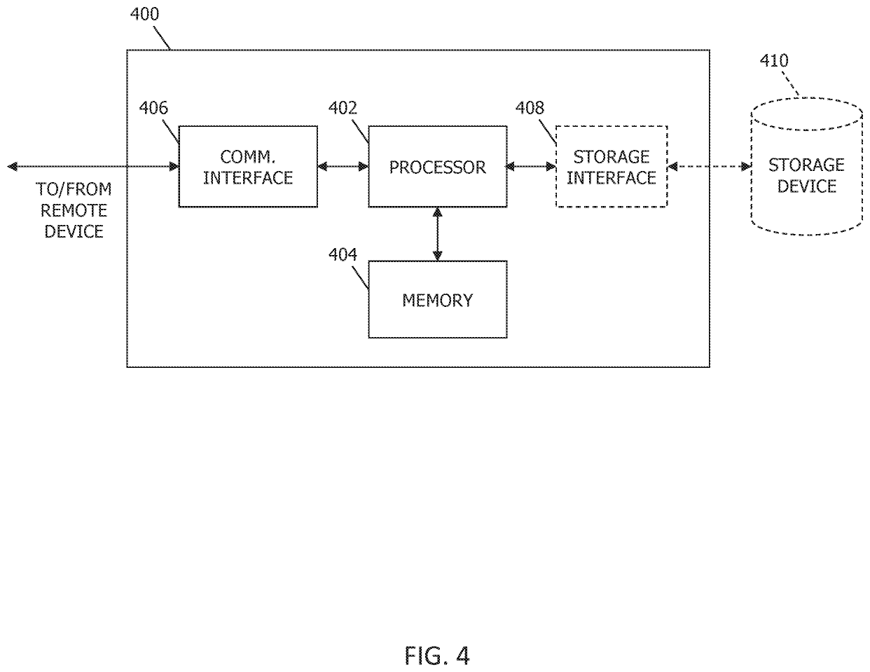

FIG. 4 is an example configuration of a server system 400, such as the messaging service system 12 (shown in FIG. 1). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as the computing devices 20, 22, 24, and/or 26, the message server 14, a client system 300, or another server system. For example, the communication interface 406 may receive communications from the user computing devices 20, 22, 24, and/or 26 and the message server 14.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like a transaction database. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the server system 400 is implemented as a software application. In such embodiments, the hardware described above, such as the processor 402, the memory area 404, the communication interface 406, and/or the storage interface 408 may be shared with the hardware components of the message server 14, such as the processor 202, the memory device 204, and/or the transceiver 210.

### Exemplary Table Records

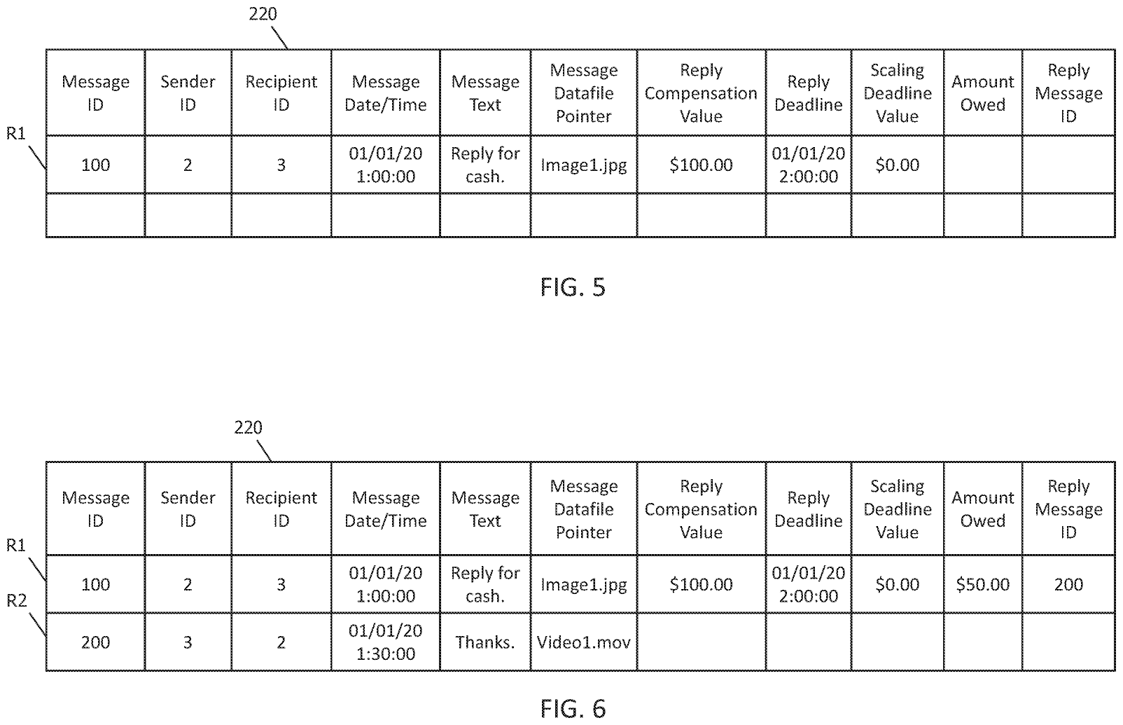

FIG. 5 is a schematic illustration of the message table 220 including a compensation message record R₁. As described above, a user, such as the user 28 (the “sender”), records an electronic compensation message, selects one or more other users (the “recipients”) to receive the recorded message, and provides a reply compensation value and reply deadline to be associated with the recorded message. The message table 220 includes a plurality of data fields (e.g., columns of the table 220), including, for example, and without limitation, at least a field for the Message ID, Sender ID, Recipient ID, Message Date/Time, Message Text, Message Datafile Pointer, Reply Compensation Value, Reply Deadline, Scaling Deadline Value, Scaling Amount Owed, and Reply Message ID. As described above, the data fields of the message records (e.g., columns of the table) can be stored in one or more tables, span two or more tables, and the like. For example, in one embodiment, the data fields may be split into two or more tables.

In the exemplary embodiment, the compensation message record R₁ is allocated a Message ID of 100 by the message module 214 (shown in FIG. 2). The Message ID is used to uniquely identify the message, such as to identify to which message a reply message is associated. For example, in one example embodiment, each message transmitted by the message server 14 (shown in FIG. 2) includes, for example, a header including various metadata. The metadata includes, for example, the message ID, and if the message is a reply message, the message ID of the message to which the reply message is associated. As such, the message module 214 matches messages to one another based on the metadata contained in the message header.

The compensation message record R₁ includes a Sender ID associated with the sender of the message. The Sender ID is mapped to the User ID of the user generating the message. The User ID is assigned to a user during registration with the messaging service system 12 (shown in FIG. 1) and is stored in the user table 222 (shown in FIG. 2). In one example, each user logs into the message server 14 before generating and/or receiving messages, and as such, the message server 14 (and in turn, the message module 214) associates each message with the user's User ID.

The compensation message record R₁ includes one or more Recipient IDs. The Recipient ID is associated with the User ID of users that the sender wishes to transmit the compensation message to. In some embodiments, the user sending the message selects one or more users (i.e., recipients) from a list of users presented via the messaging application displayed by the user interface 34 on the user's (i.e., sender's) computing device 20, 22, 24, or 26. The message module 214 enters the selected Recipient IDs into the compensation message record R₁.

In the exemplary embodiment, the date and time that the message is generated or recorded is entered into the Massage Date/Time data field. The Message Text and Message Datafile Pointer data fields include the plain text and/or pointers to datafiles, respectively, to be included in the message transmitted to the one or more Recipient IDs.

Furthermore, as described above, when a user records a compensation message, the user inputs a reply compensation value, a reply deadline, and optionally, a deadline value. The deadline value operates as an indication that the reply compensation value is scaled with respect to time. The compensation message record R₁ includes the Reply Compensation Value data field for the reply compensation value entered by the user, the Reply Deadline field for holding the date and time entered by the user, and the Scaling Deadline Value field for holding the scaling deadline value. As used herein, a scaled reply compensation value or “scaling” of the reply compensation value includes applying a diminishing value function to the reply compensation value based, in part, on a reply message date/time relative to the reply deadline.

The data fields Scaling Amount Owed and Reply Message ID are blank or null when the compensation message record R₁ is recorded by the user. These fields are updated by the message module 214 when and if a reply message is received from one or more of the message recipients.

FIG. 6 is a schematic illustration of the message table 220 including the compensation message record R₁ and a reply message record R₂. The reply message record R₂ is automatically generated by the message module 214 when a reply message is detected. In the exemplary embodiment, the reply message record R₂ corresponds to a message transmitted by a recipient of the compensation message record R₁ (e.g., User ID 3) in reply thereto.

In the exemplary embodiment, the reply message record R₂ is allocated a Message ID of 200 by the message module 214 (shown in FIG. 2). The Message ID is used to identify the message to which a reply message is associated. In one example embodiment, a header of the reply message includes, for example, the message ID and the message ID of the message to which the reply message is associated. This enables the message module 214 to match the reply message to the compensation message record R₁.

The reply message record R₂ includes a Sender ID associated with the sender of the message. As described above, the Sender ID is mapped to the User ID of the user generating the message. In addition, for a reply message, the reply message record R₂ includes the recipient ID, which is equal to the one or more recipients designated in the reply message. For example, the message may be in reply to a single sender or part of a group message. As such, the Recipient ID data field is filled with the User IDs of each recipient of the reply message.

In the exemplary embodiment, the reply message record R₂ includes the date and time that the message is generated, which is entered into the Massage Date/Time data field. The Message Text and Message Datafile Pointer data fields include the plain text and/or pointers to datafiles, respectively, that were included in the reply message.

The compensation message record R₁ is updated to include a value in the Scaling Amount Owed data field, which is determined by the message server 14, as described further herein. The Reply Message ID field is updated to include the unique Message ID assigned to the reply message by the message module 214.

### Exemplary Computer-Implemented Methods

The operations for the computer-implemented methods described herein may be performed in the order shown in the respective figures, or according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented methods are described below, for ease of reference, as being executed by exemplary devices and components introduced with the embodiments illustrated in FIGS. 1-6. In one embodiment, the message server 14 (shown in FIG. 2) implements the computer-implemented methods. In the exemplary embodiment, the computer-implemented methods relate to tracking message interactions and providing compensation for responding to certain messages. While operations within the computer-implemented methods are described below regarding the message server 14, according to some aspects of the present invention, the computer-implemented methods may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

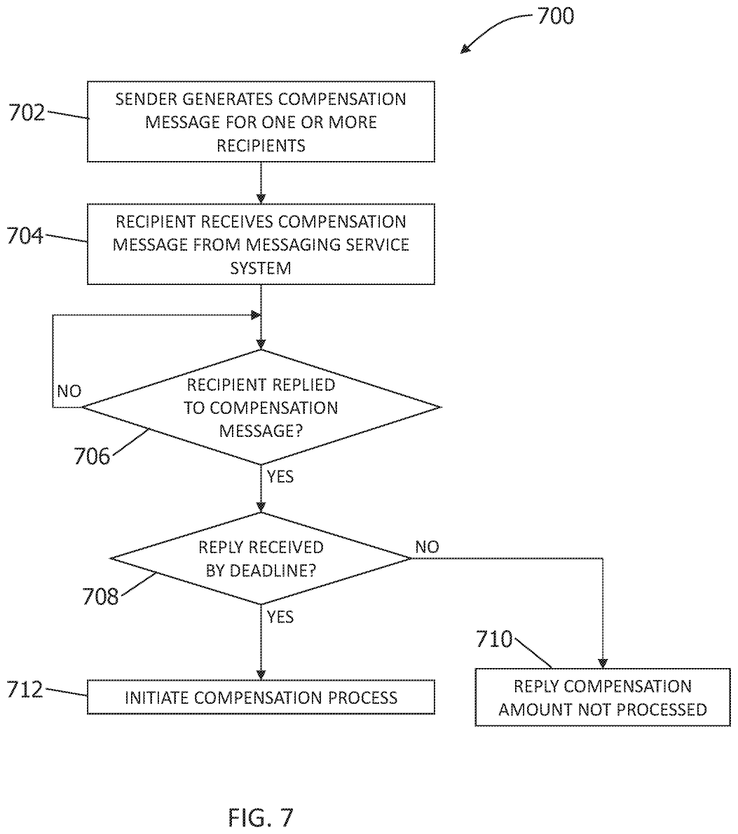

FIG. 7 is a flowchart illustrating an exemplary computer-implemented method 700 for determining a compensation amount owed to a message recipient for replying to a compensation message, in accordance with one embodiment of the present disclosure. At operation 702, in the example embodiment, the message sender (e.g., the user 28 (shown in FIG. 1)) generates a compensation message for one or more recipients (e.g., the user 30 (shown in FIG. 1)). In particular, the message server 14 receives from the sender input data associated with a compensation message the sender wishes to send to one or more recipients via the message server 14 and generates the compensation message therefrom. The input data provided by the send includes, for example, and without limitation, a reply compensation value, a reply deadline, a recipient, and message content (e.g., text, emojis, and/or datafiles). The message module 214 (shown in FIG. 2) monitors input data received by the message server 14. When the message module 214 identifies a compensation message request input, it writes a compensation message record, such as the compensation message record R₁ (shown in FIG. 5), to the message table 220 (shown in FIG. 2). As described herein, in one example, the compensation message record functions as the compensation message.

More particularly, the upon receipt of a compensation message request by a user, such as the user 28 (the “sender”), the message server 14 collects various information from the sender, the database 16, and/or the messaging service system 12 (shown in FIG. 1). For example, the message server 14 collects a message ID (e.g., allocated by the message server 14), sender ID, recipient ID(s), message date/time (e.g., from an internal clock of the message server 14), message text and/or message datafile pointer, reply compensation value, and reply deadline, and optionally, a scaling deadline value. In one embodiment, the sender ID and recipient ID(s) may be obtained, for example, from the user table 222 by matching the sender (e.g., user 28) and recipients to the associated user records, such as user records UR₁, UR₂, and UR₃ (shown in FIG. 2).

At operation 704, the recipient receives the compensation message from the messaging service system 12, and more particularly, from the message server 14. In one suitable embodiment, the message server 14 transmits an audible and/or visual message notification or alert to the recipient, for example, via the messaging application installed on the user computing device 20, 22, 24, or 26, via email, SMS message, and the like. The notification or alert may include, for example, a graphical display change, icon change, icon flash, audible tone, tone sequence, etc. In the exemplary embodiment, the recipient may be presented with the sender information (e.g., name, etc.), the reply compensation value, and the reply deadline. The recipient may select to open the compensation message, for example, within the messaging application, to view the message content and to, optionally, reply to the compensation message. In one example, opening the compensation message includes reading the information or data contain in the compensation message record.

At operation 706, the message server 14 determines whether the recipient has replied to the compensation message, and at operation 708, determines whether the reply message is received by the deadline specified by the sender of the compensation message. In particular, if the recipient replies to the compensation message, the message module 214 identifies the incoming reply message (e.g., a reply message request) and writes a reply message record R₂ to the message table 220. For example, the message server 14 collects a message ID (e.g., allocated by the message server 14), sender ID, recipient ID, message date/time (e.g., from an internal clock of the message server 14), message text and/or message datafile pointer, and optionally, a reply compensation value and reply deadline. If a reply compensation value and reply deadline are collected, the message server 14 may optionally collect a scaling deadline value from the recipient as well. In one embodiment, the sender ID and recipient ID may be obtained, for example, from the user table 222 by matching the reply sender (e.g., user 30) and recipient to the associated user records, such as user records UR₁, UR₂, and UR₃ (shown in FIG. 2).

In one example embodiment, the message module 214 searches the message table 220 to identify instances (e.g., message exchanges) where the reply message record R₂ has a message date/time that is equal to or less than the Reply Deadline of a previous message record (e.g., the compensation message record R₁), the Sender ID of the reply message record R₂ includes a Recipient ID of the previous message record, the Recipient ID of the reply message record R₂ includes the Sender ID of the previous message record, and the reply message compensation has not been satisfied (e.g., the Reply Message ID data field is NULL). In such instances, the messages (i.e., the reply message record R₂ and the identified previous message record matching the criteria) are associated as compensation message/replay message.

If the Message Date/Time data field of the reply message record R₂ is less than or equal to the Reply Deadline data field of the previous message record, such as the compensation message record R₁, the message module 214 updates the Reply Message ID data field of the compensation message record R₁ with the Message ID of the reply message record R₂, and the method 700 continues to operation 712. However, if the Message Date/Time data field of the reply message record R₂ is greater than the Reply Deadline data field of the compensation message record R₁, the method 700 ceases to process a compensation amount at operation 710, and no compensation is owed to the recipient.

At operation 712, the message server 14 initiates the compensation process and determines the compensation amount owed to the recipient. In particular, the compensation determination module 218 (shown in FIG. 2) of the message server 14 calculates a reply compensation value that is due to be paid to the recipient by the sender based on the entry in the Reply Compensation Value data field of the compensation message record R₁. In some embodiments, the reply compensation value is determined by the Reply Compensation Value data field of the compensation message record R₁ and the reply message date/time relative to the deadline provided by the sender.

In certain embodiments, after a compensation value is determined, the message server 14, and more particularly, the compensation determination module 218, transmits payment transaction data to the payment processor 32 (shown in FIG. 1), including, for example, a payment sender identification, payment receiver identification, and compensation amount. The transaction includes, for example, payment account data of the sender and the recipient, and a reply compensation value to be paid by the sender to the recipient.

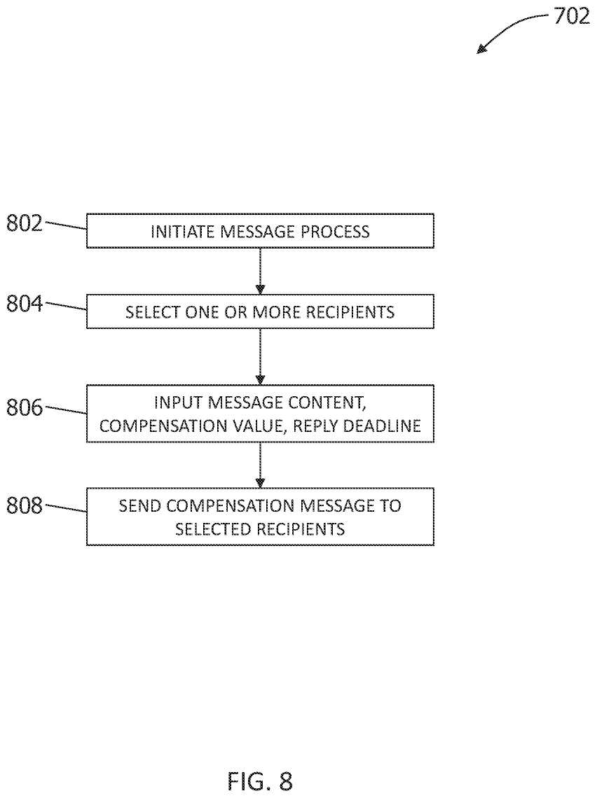

FIG. 8 is a flowchart illustrating the operations of step 702 of the method 700, described above. At operation 802, the sender initiates, via the messaging application for example, a messaging process for generating, for example, a new compensation message for one or more recipients (e.g., the user 30 (shown in FIG. 1)). In one embodiment, the sender logs into his or her messaging account with the messaging service system 12 using, for example, the messaging application installed on the user computing device 20, 22, 24, or 26.

At operation 804, the sender selects one or more recipients to receive the compensation message, or in some embodiments, replies to one or more users. In the exemplary embodiment, the sender selects recipients from a list of active users of the messaging service system 12. Alternatively, or additionally, the sender may add one or more recipients that are not active users. For example, and without limitation, the sender may input a telephone number that can receive SMS messages, an email address, or other electronic communication method, for the additional recipients that are to receive the compensation message.

At operation 806, the sender inputs the compensation message content, such as a text message, an emoji, and/or a datafile. In addition, the sender inputs the reply compensation value and the reply deadline. In certain embodiments, the sender may include additional details such as a scaling deadline value indicating that the reply compensation value is scaled, for example, with time.

In particular, the message server 14 collects various information from the sender, the database 16, and/or the messaging service system 12 (shown in FIG. 1). For example, the message server 14 collects a message ID (e.g., allocated by the message server 14), sender ID, recipient ID(s), message date/time (e.g., from an internal clock of the message server 14), message text and/or message datafile pointer, reply compensation value, and reply deadline, and optionally, a scaling deadline value. In one embodiment, the sender ID and recipient ID(s) may be obtained, for example, from the user table 222 by matching the sender (e.g., user 28) and recipients to the associated user records, such as user records UR₁, UR₂, and UR₃ (shown in FIG. 2). At operation 810, the sender transmits the compensation replay message to the one or more recipients, for example, by pressing a “SEND” option within the messaging application.

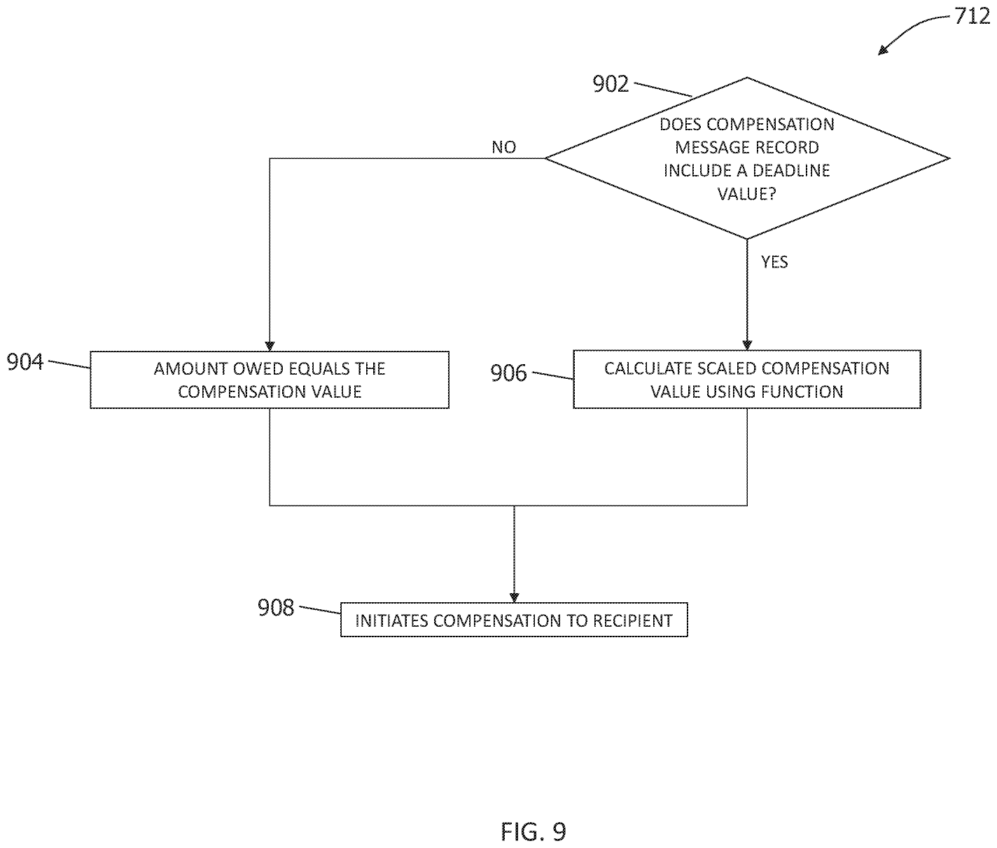

FIG. 9 is a flowchart illustrating the operations of step 712 of the method 700, described above. To determine the compensation amount owed to a recipient, at operation 902, the compensation determination module 218 determines whether the compensation message record R₁ includes a value in the Scaling Deadline Value data field. A value entered in the field indicates that the reply compensation value is scaled, and the method continues at operation 906. If the Scaling Deadline Value data field is NULL, at operation 904, the method determines that the reply compensation value is not scaled, and as such, the reply compensation amount owed to the recipient is the value contained in the Reply Compensation Value data field. In one example embodiment, the compensation determination module 218 may update the Scaling Amount Owed data field of the compensation message record R₁ with the value of the Reply Compensation Value data field.

If the Scaling Deadline Value data field of the compensation message record R₁ includes a value (including zero (0)), at operation 906, the compensation determination module 218 calculates the reply compensation amount owed to the recipient using, for example a diminishing value function. In the exemplary embodiment, the diminishing value function is a linear regression function. In an example illustrated in FIGS. 5 and 6, the compensation message record R₁ includes a reply compensation value of $100 (“CVR₁”) and a scaling deadline value of $0.00 (“DVR₁”). In addition, the compensation message record R₁ includes a message date and time of 01/01/20, 1:00:00 (“MDR₁”) and a reply deadline of 01/01/20, 2:00:00 (“RDR₁”). The reply message record R₂ includes a message date and time of 01/01/20, 1:30:00 (“MDR₂”). One example formula for determining the reply compensation amount owed is:

$$C V {R}_{1} + ( \frac{( D V {R}_{1} - C V {R}_{1} )}{( R D {R}_{1} - M D {R}_{1} )} \times ( M D {R}_{2} - M D {R}_{1} ) ) = scaling amount owed$$

Plugging in the values gives the following:

$$\$ 100 + ( \frac{( \$ 0.00 - \$ 100 )}{( 2 \text{:} 00 - 1 \text{:} 00 )} \times ( 1 \text{:} 30 - 1 \text{:} 00 ) ) = \$50 = scaling amount owed$$

Thus, in the example linear regression formula and for the values given above, a recipient that replies thirty (30) minutes after the compensation message time, which has a reply period of sixty (60) minutes, will receive a reply compensation amount of $50. It is noted that the above described formula is just an example and that many different diminishing value functions can be used to determine the reply compensation amount owed.

In one example embodiment, the compensation determination module 218 updates the Scaling Amount Owed data field of the compensation message record R₁ with the calculated, scaled reply compensation value determined above.

At operation 908, the message server 14 initiates the compensation to the recipient. For example, in one suitable embodiment, the compensation determination module 218, transmits payment transaction data to the payment processor 32 (shown in FIG. 1). The transaction includes, for example, payment account data of the sender and the recipient, and a reply compensation value to be paid by the sender to the recipient.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A server comprising:
a database comprising a message table having a plurality of message records; and
a processor in communication with said database, said processor programmed to:
receive, from a sender via a remote computing device, input data associated with a compensation message, the input data including a reply compensation value, a reply deadline, a recipient, and message content;
generate the compensation message based on the input data;
transmit the compensation message to the recipient;
receive a reply message from the recipient, the reply message associated with the compensation message;
determine that the reply message was received before or equal to the reply deadline; and
determine a compensation value associated with the reply message based on the reply compensation value.

2. The server in accordance with claim 1,
said processor programmed to determine that the reply message was received before or equal to the reply deadline comprises said processor further programmed to compare a message date and time of the reply message to the reply deadline of the compensation message.

3. The server in accordance with claim 1,
said processor further programmed to write a compensation message record to said message table, the compensation message record including a plurality of data fields, the plurality of data fields including one or more of the following: Message ID, Sender ID, Recipient ID, Message Date/Time, Message Text, Message Datafile Pointer, Reply Compensation Value, Reply Deadline, and Scaling Deadline Value,
wherein the reply compensation value is written to the Reply Compensation Value data field, the reply deadline is written to the Replay Deadline data field, and the recipient includes a user ID written to the Recipient ID data field.

4. The server in accordance with claim 3,
said processor programmed to determine a compensation amount owed to the recipient comprising said processor further programmed to:
determine that the compensation message record includes a NULL in the Scaling Deadline Value data field; and
write to the Scaling Amount Owed data field of the compensation message record the reply compensation value.

5. The server in accordance with claim 3, wherein the input data further includes a deadline value,
said processor programmed to write the deadline value to the Scaling Deadline Value data field,
said processor further programmed to write a reply message record to said message table, the reply message record corresponding to the reply message received from the recipient,
said processor programmed to determine a compensation amount owed to the recipient comprising said processor further programmed to:
determine that the compensation message record includes a deadline value in the Scaling Deadline Value data field;
calculate a reply compensation amount owed to the recipient using a diminishing value function; and
write to the Scaling Amount Owed data field of the compensation message record the calculated reply compensation value.

6. The server in accordance with claim 5,
the diminishing value function including a linear regression function.

7. The server in accordance with claim 1,
said processor further programmed to transmit transaction data to a payment processor, the transaction data including the compensation amount and payment account data associated with the recipient and the sender.

8. A method comprising:
receiving, from a sender via a remote computing device, input data associated with a compensation message, the input data including a reply compensation value, a reply deadline, a recipient, and message content;
generating the compensation message based on the input data;
transmitting the compensation message to the recipient;
receiving a reply message from the recipient, the reply message associated with the compensation message;
determining that the reply message was received before or equal to the reply deadline; and
determining a compensation value associated with the reply message based on the reply compensation value.

9. The method in accordance with claim 8,
wherein determining that the reply message was received before or equal to the reply deadline comprises comparing a message date and time of the reply message to the reply deadline of the compensation message.

10. The method in accordance with claim 8 further comprising writing a compensation message record to a message table, the compensation message record including a plurality of data fields,
the plurality of data fields including one or more of the following: Message ID, Sender ID, Recipient ID, Message Date/Time, Message Text, Message Datafile Pointer, Reply compensation value, Reply Deadline, and Scaling Deadline Value,
wherein the recipient includes a user ID, and
wherein writing the compensation message record to the message table comprises writing the reply compensation value to the Reply Compensation Value data field, the reply deadline to the Replay Deadline data field, and the user ID written to the Recipient ID data field.

11. The method in accordance with claim 10,
wherein determining the compensation amount owed to the recipient comprises:
determining that the compensation message record includes a NULL in the Scaling Deadline Value data field; and
writing to the Scaling Amount Owed data field of the compensation message record the reply compensation value.

12. The method in accordance with claim 10,
wherein the input data further includes a deadline value,
wherein writing the compensation message record to the message table comprises writing the deadline value to the Scaling Deadline Value data field,
said method further comprising writing a reply message record to the message table, the reply message record corresponding to the reply message received from the recipient,
wherein determining the compensation amount owed to the recipient comprises:
determining that the compensation message record includes a deadline value in the Scaling Deadline Value data field;
calculating a reply compensation amount owed to the recipient using a diminishing value function; and
writing to the Scaling Amount Owed data field of the compensation message record the calculated reply compensation value.

13. The method in accordance with claim 12, wherein the diminishing value function includes a linear regression function.

14. The method in accordance with claim 8 further comprising transmitting transaction data to a payment processor, the transaction data including the compensation amount and payment account data associated with the recipient and the sender.

15. One or more non-transitory computer-readable storage media having computer-executable instructions embodied thereon, wherein when executed by at least one processor, the computer-executable instructions cause the processor to:
receive, from a sender via a remote computing device, input data associated with a compensation message, the input data including a reply compensation value, a reply deadline, a recipient, and message content;
generate the compensation message based on the input data;
transmit the compensation message to the recipient;
receive a reply message from the recipient, the reply message associated with the compensation message;
determine that the reply message was received before or equal to the reply deadline; and
determine a compensation value associated with the reply message based on the reply compensation value.

16. The computer-readable storage media in accordance with claim 15,
wherein determining that the reply message was received before or equal to the reply deadline comprises the computer-executable instructions causing the processor to compare a message date and time of the reply message to the reply deadline of the compensation message.

17. The computer-readable storage media in accordance with claim 15,
the computer-executable instructions further causing the processor to write a compensation message record to a message table, the compensation message record including a plurality of data fields,
the plurality of data fields including one or more of the following: Message ID, Sender ID, Recipient ID, Message Date/Time, Message Text, Message Datafile Pointer, Reply compensation value, Reply Deadline, and Scaling Deadline Value,
wherein the recipient includes a user ID, and
wherein writing the compensation message record to the message table comprises writing the reply compensation value to the Reply Compensation Value data field, the reply deadline to the Replay Deadline data field, and the user ID written to the Recipient ID data field.

18. The computer-readable storage media in accordance with claim 17,
wherein determining the compensation amount owed to the recipient comprises the computer-executable instructions causing the processor to:
determine that the compensation message record includes a NULL in the Scaling Deadline Value data field; and
write to the Scaling Amount Owed data field of the compensation message record the reply compensation value.

19. The computer-readable storage media in accordance with claim 17,
wherein the input data further includes a deadline value,
wherein writing the compensation message record to the message table comprises the computer-executable instructions causing the processor to write the deadline value to the Scaling Deadline Value data field,
the computer-executable instructions further causing the processor to write a reply message record to the message table, the reply message record corresponding to the reply message received from the recipient,
wherein determining the compensation amount owed to the recipient comprises the computer-executable instructions causing the processor to:
determine that the compensation message record includes a deadline value in the Scaling Deadline Value data field;
calculate a reply compensation amount owed to the recipient using a diminishing value function; and
write to the Scaling Amount Owed data field of the compensation message record the calculated reply compensation value.

20. The computer-readable storage media in accordance with claim 19, wherein the diminishing value function includes a linear regression function.
